(19) United States
(12) Patent Application Publication
(10) Pub. No.: US 2014/0257771 A1
(43) Pub. Date: Sep. 11, 2014

(54) NUMERICAL SIMULATION METHOD FOR AIRCRASFT FLIGHT-ICING

(71) Applicant: Ming Lu, Tianjin (CN)

(72) Inventor: Ming Lu, Tianjin (CN)

(21) Appl. No.: 13/978,709

(22) PCT Filed: Nov. 30, 2011
(86) PCT No.: PCT/CN2011/083190

§ 371 Date: Jul. 8, 2013

(51) Int. Cl. G06F 17/50

(52) U.S. Cl. CPC G06F 17/5009
USPC 703/2

(57) ABSTRACT

The present invention is related to a numerical simulation method for aircraft flight-icing. This invention mainly includes an algorithm for velocity decomposition on the water film in simulating the air-supercooled water droplets movement using the single fluid two-phase flows system; an algorithm for tracking the icing interface and obtaining the temperature distribution inside the ice layer using the grid refinement scheme; the computing procedure using above-mentioned algorithms based on the fixed computing grid.

### TECHNICAL FIELD OF THE INVENTION

The present invention is related to the application of computational fluid dynamics (CFD) on the aerospace engineering. Particularly, it is a numerical simulation method for aircraft flight-icing. This method can be implemented using the computer language codes and can be run on computers to simulate the state of aircraft flight-icing.

### BACKGROUND OF THE INVENTION

At a certain attitude range of aircrafts flying, the supercooled water droplets (SWD) in atmosphere, which are at temperature below the freezing point but exist in form of particles, may impact on aircraft surfaces and form the water films (WF). If the supercooled liquefied water content (LWC, the mass of the SWD per unit volume, with dimension kg/m³) in atmosphere is too high, the WF adhering on aircraft surfaces starts to accrete into ice. This phenomenon is called the flight-icing. Ice accretion on some critical control surfaces of aircraft, such as wing, stabilizer, engine inlet, engine blades, etc. has a significant impact on operation and controllability of aircraft. For examples, it may shift the gravity center of aircraft, freeze movable components, result in substantial decrease of lift and increase in drag, reduce stall margin, etc., which even cases the stability and control problems to a point of aviation disaster.

In order to ensure flight safety in icing conditions and meet the FAA or other aircraft certification regulations, which requires an aircraft to be able to operate safely throughout the icing envelop, the icing protection mechanism has to be employed on some critical locations of an aircraft. The icing anti/de-icing analysis and icing certifications are performed by a combination of the natural flight test, icing wind tunnel test and numerical simulation because each has exhibit some deficiencies. The natural flight test has seasonal limitations and is risky in some extreme situations. It cannot test full range of the icing envelope required by FAR Part 25. The icing wind tunnel experimental testing is usually done at low Reynolds number (Re) and cannot simply extrapolate the result to high Re for larger aircrafts. Moreover, the generation of the size distribution of SWD like in atmosphere in the icing wind tunnel is not possible.

Since the 80 s last century, the numerical simulation technology to the flight-icing had been studied extensively in the world not only in theory but also in engineering applications. It had become a supporting tool for analysis and certification. The advanced numerical simulation technology can correct the error and deficiencies in wind tunnel testing. After 30 year long developing, the numerical simulation to the flight-icing has realizes software products with industrial applicable level, such as the software LEWICW from USA, ONERA from France and Fensap from Canada.

The procedure applied in such flight-icing simulation software is about the call instructions to three main modules, whose function respectively are following

The Air Flow Simulation Module:

solving the fluid flow governing equations, a set of partial difference equations (PDE), for the state of external flow field and surfaces of aircraft;

The SWD Movement Simulation Module:

solving the SWD movement governing equation for the impingement of the SWD to aircraft surfaces to find the state of liquid water on aircraft surfaces;

Icing Accretion Module:

solving the physical model describing the icing state of the WF on aircraft surfaces to find ice geometry.

There are some differences in the technology used in the software above-mentioned. Firstly, the panel method is used in LEWICE and ONERA, which means that an incompressible flow field around aircraft is assumed; an air-SWD two-phase flow is assumed in FENSAP, where only the effect of the air to the SWD is accounted for. Secondly, the Lagrangian frame is used in LEWICE, where the SWD are tracked as to be limited to treat a complex configuration of aircraft; while the Euler frame is used in ONERA and FENSAP. For the icing process, the famous Messinger model, a zero-dimensional, expressed as an ordinarily difference equation derived from the mass and energy conservation law with assumption of even-distributed physical properties in ice layer, is referred for all software. In LEWICE and ONERA, the icing progress is considered as a quasi-steady based on an assumption that during a time period all external flows are constant, which obviously is not correct in case the external flows have separation; while in Fensap a time dependent term related to icing accretion is built to overcome this deficiency in the cost of another two PDE to be solved.

All software needs to regenerate the computing grid in each time step since the change of ice geometry, which has to take the grid interpolation, smoothing and orthogonal treatment and the variables interpolation. It not only takes extras computing time, but also reduces the whole computing precision due to interpolations.

The FIG. 1 presents a flow chart of aircraft flight-icing simulation in FENSAP. It shows that in each time step, the external flow field firstly is resolved to obtain the properties of the air and the SWD, then the water collection efficiency, wall stress, wall heat flux, etc are brought into the icing accretion model to obtain the ice geometry, and the grid generation, interpolation, smoothing and orthogonal treatment based on the new aircraft configuration further is taken. It is reported that for a simulation to a NACA0012 two-dimensional airfoil with 470000 grid points on a computer with 8 CPU it needs 3.5 hours, of which the grid generation time costs 15%.

### SUMMARY OF THE INVENTION

The present invention is a numerical simulation method for aircraft flight-icing, which can be embodied using the computer language codes and can be run on computers to simulate the state of aircraft flight-icing. This method is pursuing the high efficiency, precision and multifunction.

This invention mainly includes three originalities: 1. an algorithm about velocity decomposition on the WF in simulating the air-SWD movement using the single fluid two-phase flows system; 2. an algorithm about tracking the icing interface and obtaining the temperature distribution inside the ice layer using the grid refinement scheme; 3. the computing procedure using above-mentioned algorithms based on the fixed computing grid.

The so-call single fluid two-phase flows system for simulating the air-SWD movement is a set of PDE to describe the flow field around aircraft. In this invention, the air and the SWD two phase flows are considered as an equivalent mixture fluid flow. On the surface of the WF or the icing interface, the velocity of the mixture flows needs to be decomposed as two velocities corresponding to two phase properties.

For the simulation for the temperature distribution inside the ice layer, there needs a set of PDE to describe the WF movement and phase changing and to recognize the icing interface.

In atmosphere, the SWD, with the MVD (Medium Volume Diameter) small than 50 μm are evenly distributed into the convection air flows, which reasonably become an air-SWD mixture fluid. The flows closely around aircraft are the air-SWD two-component mixtures, which are homogeneous within a small fluid particle and can be considered as continuum, which is equivalent to a single component fluid. The governing equations of this fluid can be built based on assumption of single-fluid two-phase system, where the physical properties, such as density, specific heat, viscosity, heat conduction, etc. can be obtained from the weight-averaged volume fraction of different phases. The velocity of the mixture can be obtained from the mass-weighted average. In the two-component mixture, the volume fraction is α; while the density, velocity vector, and the viscosity is respectively ρₘ, \vec{U}ₘ and μₘ. Any variable with subscript m presents mixture, 1 for air, and 2 for SWD. Obviously, it has

$$\begin{matrix}{α}_{1} + {α}_{2} = 1 , & ( 1 ) \\ {ρ}_{m} = {α}_{1} {ρ}_{1} + {α}_{2} {ρ}_{2} , & ( 2 ) \\ {μ}_{m} = {α}_{1} {μ}_{1} + {α}_{2} {μ}_{2} , & ( 3 ) \\ {{U}^{->}}_{m} = \frac{1}{{ρ}_{m}} ( {α}_{1} {ρ}_{1} {{U}^{->}}_{1} + {α}_{2} {ρ}_{2} {{U}^{->}}_{2} ) . & ( 4 )\end{matrix}$$

The formation of the governing equations for the air-SWD single fluid two-phase flows, including the phase diffusion, continuity, momentum, energy equation, is identical to that of for the single phase flows. Meanwhile, this conclusion is also suitable to the turbulence models. The interaction between the two phases is reflected by a phase fraction diffusion equation.

The numerical scheme, such as spatial and temporal discretization, for the single fluid two-phase flows, also can be used for the single phase flows. The solution supplies the information such as the density, pressure, velocity, temperature, viscosity and turbulence of the air and the SWD at the computing grid points of flow field around aircraft.

The WF with thickness forms in the wall boundary cells on the surface of aircraft. The icing progress will firstly happens between the WF and the clean wall surface of aircraft to form an ice layer and then does between the WF and the ice layer outwards.

The present invention starts from the decomposition of the mixture velocity to obtain the two velocities for the two phases. Its principle lies in that

Assuming that all SWD form an imaginary water film (IWF) with a thickness decided by α₂ in the wall boundary cells and the velocity of the IWF is equal to the SWD velocity. Therefore, the velocity and thickness of the real WF can be obtained from the velocity of the IWF and the integration to the characteristic time.

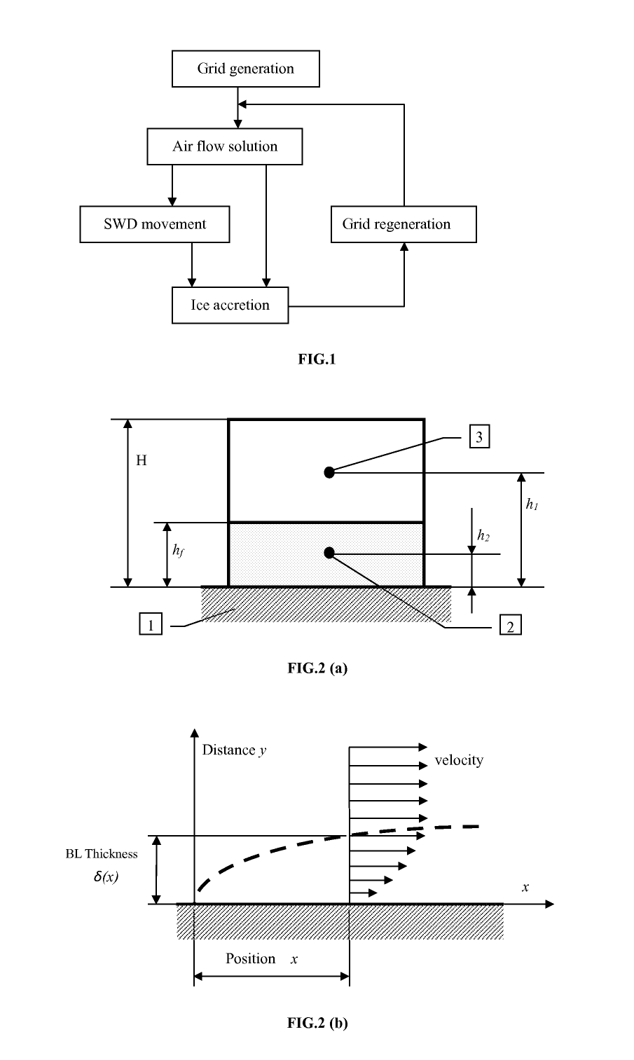

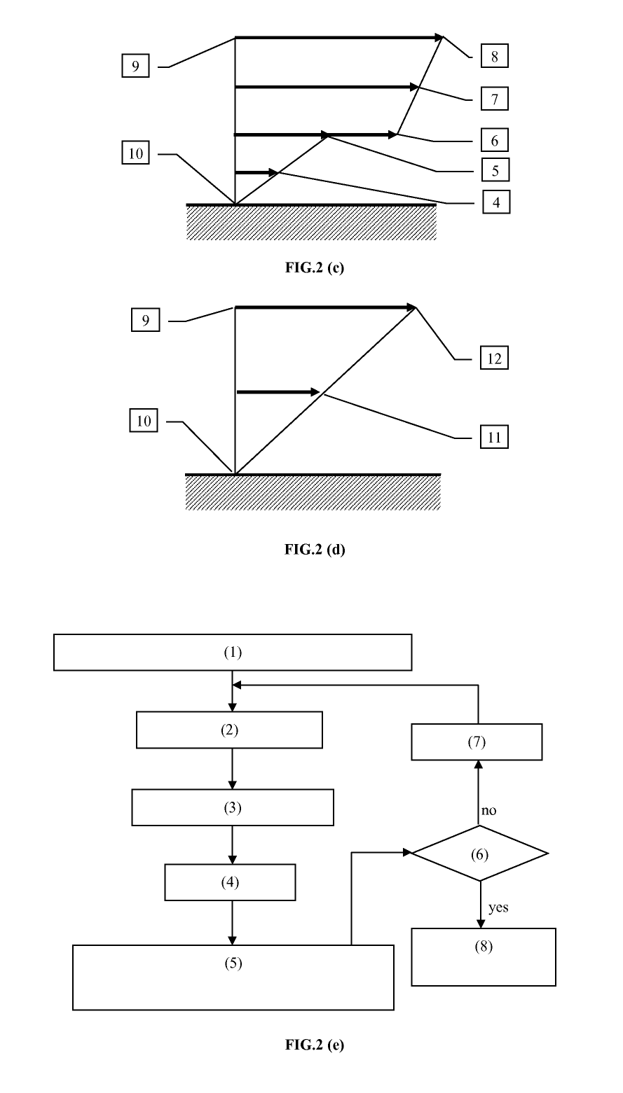

The FIG. 2 gives the principle of the velocity decomposition. The FIG. 2 (a) illustrates the decomposition of the air-SWD mixture flows and the formation of the IWF in the wall boundary cells using a two-dimensional case as an example. Firstly, using α₂, the volume fraction of SWD, one can obtain h_{f}, the thickness of the IWF in a boundary cell with height H, within which another part is occupied with the air. From the wall (1) to the geometry center of air part (3), the height is h₁; while to (2), the center of IWF part, the height is h₂. Here, the wall (1) could be the clean wall surface of aircraft or the iced surface (ice layer). The IWF is an incompressible flow and forms a boundary layer (BL) on the wall (1) as shown in the FIG. 2 (b). Based on the classic boundary layer theory, the velocity distribution in inside the BL, u(x, y), can be obtained from the Blasius formula

$$\frac{u ( x , y )}{{U}_{∞}} = \frac{2 y}{δ ( x )} - {( \frac{y}{δ ( x )} )}^{2} , \qquad ( 5 )$$

where (x, y) locates a position, y is the distance to the wall and U_{∞} is the velocity of incoming flows. The thickness of the BL, δ(x), is expressed as

$$δ ( x ) = 5 \sqrt{\frac{x v}{{U}_{∞}}} , \qquad ( 6 )$$

where v is the kinematic viscosity. If U_{∞} and v determined, from (5-6), one can decides the velocity u at the point (x, y) in the BL.

Following the FIG. 2 (a, b), a sketch of the velocity distribution in the assumed air-IWF two-fluid BL is presented in the FIG. 2 (c). Along h_{f}, the interface of IWF and air, there are two velocities, the IWF surface velocity u_{2f} pointed by D(5) and the air velocity pointed by C(6). The IWF velocity, u₂, is located in the geometry center of the water part in the air-IWF two-fluid BL. u₁, the air velocity, is located at the geometry center of the air part, h₁. The air velocity at H is pointed by B (8) and the non-slip velocity point is done by A (10).

At the same time, the velocity distribution in the air-SWD mixture BL is shown in the FIG. 2 (d), hₘ is half of H and where the mixture velocity is uₘ (11) and at H the mixture velocity is pointed by E (12). The air velocity at H and the mixture velocity at H both start from point O (9).

Besides that, it needs to assume that the geometry integration to the velocity of the air-IWF two-fluid flow BL should be equal to that of the air-SWD mixture BL, which means that the area ADCBO in the FIG. 2 (c) is equal to that AEO in the FIG. 2 (d). The FIG. 2 (e) shows the procedure to calculate u_{2f}, the surface velocity of imaginary WF
(1) Initialize v as the kinetic viscosity of the IWF on the wall surface.
(2) Bring (6) into (5), replacing y with h_{f}, to find u_{2f}, the surface velocity of the IWF.
(3) Calculate u₂, the IWF velocity at h₂ according to

$${u}_{2} = \frac{1}{2} {u}_{2 f} . \qquad ( 7 )$$

(4) Calculate u₁, the air velocity according to the equation (4)

$${u}_{1} = \frac{{ρ}_{m} {u}_{m}}{{α}_{1} {ρ}_{1}} - {u}_{2} . \qquad ( 8 )$$

(5) Calculate area S enclosed by ADCBO and Sₘ enclosed by AEO, according to

$$\begin{matrix}S = \frac{1}{2} {u}_{2} {h}_{f} + {u}_{1} ( H - {h}_{f} ) , & ( 9 ) \\ {S}_{m} = \frac{1}{2} {u}_{m} H . & ( 10 )\end{matrix}$$

(6) Measure S and Sₘ, if the differential between them under specified error, go to step (8).
(7) Go back to step (2) with an adjusted v to find u_{2f}.
(8) calculate v₂, the normal velocity of the IWF, following the incompressible BL theory

$${v}_{2} = \frac{0.8604 \cdot v}{{U}_{∞} \cdot x} {u}_{2 f} . \qquad ( 11 )$$

and modify the IWF thickness as

h_{f}=v₂·Δt, (12)
where Δt is the characteristic integration time.
   The WF surface velocity \vec{U}_{2f} can be obtained based on the assumption of the linear velocity distribution in the real WF BL, which means that the ratio of \vec{U}_{2f} to u₂ is equal to that h_{f} to h₂.

Until now, based on the velocity decomposition for the air-SWD single fluid two-phase flow, the water film surface velocity \vec{U}_{2f} is obtained, which, as the important boundary condition, is used for the computation of the icing progress model.

This invention supplies an icing progress model with the function of calculating the ice layer shape and the temperature distribution inside it by using the grid refinement to track the icing interface. Since the flight-icing is caused by the phase changing in the WF formed from impingement of SWD, it is sensible to generate a computational domain for the icing process, which covers the WF and the wall or the iced layer. And between them is the icing interface.

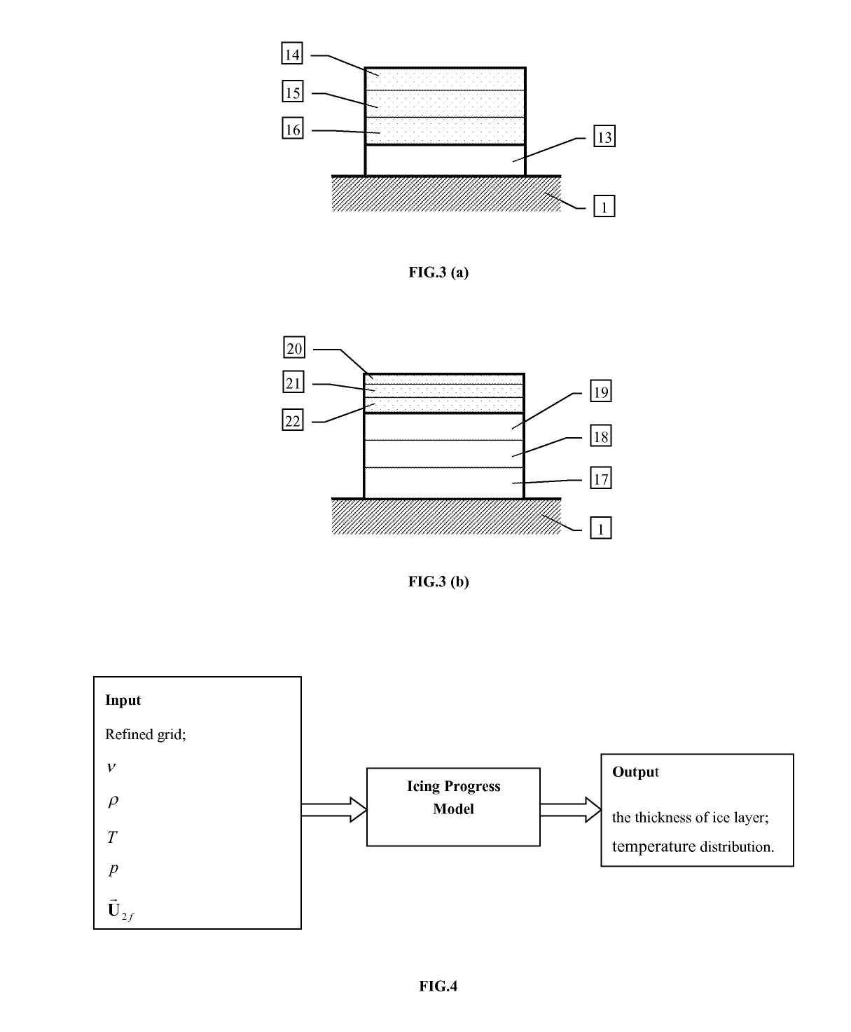

The icing progress model proposed in the invention needs at least three layer new computing cells in the bottom of the WF in the wall boundary cells and another three ones inside the ice layer. Those six cells refine the original computing cells and constitute the phase changing zone, where the water changes into ice and new icing interface appears. The FIG. 3 presents the principle of grid refinement to track the icing interface. In FIG. 3 (a), at the time t, three cells (14,15,16), covering the thickness of the WF, are regenerated above (13), the ice layer formed in the last time step, on (1), the wall of aircraft. This grid refinement makes the three cells also cover the new icing interface. In FIG. 3 (b), at time t+t, some water has changed into ice where needs three cells (17,18,19) on the bottom and a new WF forms on the upper, where needs to regenerate another three cells (20,21,22) coving the new WF. If the WF is on the clean wall surface, the publicly known Messinger model, a zero-dimensional model without accounting for the temperature distribution inside ice layer, is used to calculate the ice shape.

After the grid refinement, it starts to calculate the icing progress, which can be considered as a liquid-solid two-phase fluid with phase changing flow case. Its governing equations include the continuity, momentum, energy equation. The solution by the publicly known method gives the temperature distribution in the two-phase fluid and phase changing properties, which can be transferred into the ice shape. The FIG. 4 shows the input and output in this calculation. The input parameters include the WF surface velocity, external boundary temperature; while the output does the thickness of ice layer and temperature distribution.

If the ice thickness is equal to that of WF, the ice is the rime ice; otherwise it is the glace ice. In this case, it needs to convert the un-iced left water into the SWD volume fraction in computing cells for the purpose of using it as a boundary condition for the next time step computation. For example, if the thickness of the un-iced left water h′ₘ, where superscript ′ means the converted parameter. From the FIG. 2 (a),

$$\frac{2 {h}_{1} - {h}_{m}^{′}}{{h}_{m}^{′}} = \frac{{α}_{1}^{′}}{{α}_{2}^{′}} . \qquad ( 13 )$$

And obviously, α′₁+α′₂=1, which also follows the equation (1).

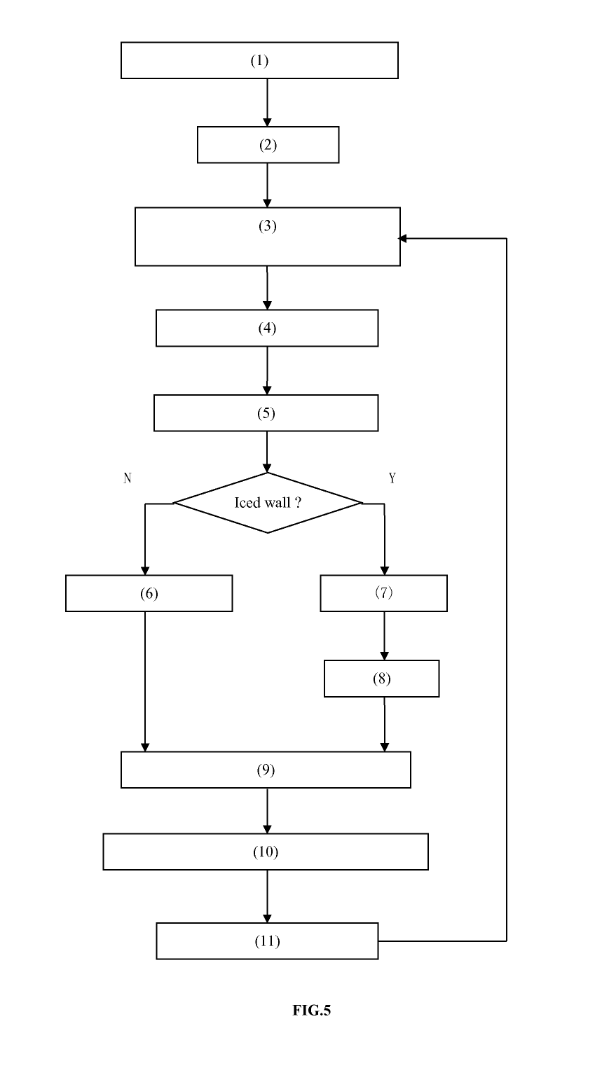

After finishing the computation in a time step, a new wall surface forms, which needs to be remarked, and then continuing the next time step. The FIG. 5 presents the procedure for the numerical simulation for the aircraft flight-icing. In detailed,
(1) generate the computing grid for the clean aircraft;
(2) initialize the starting time;
(3) solve the governing equations for the air-SWD single fluid two-phase flows for aircraft external flow field simulation;
(4) calculate the thickness of the imaginary WF in the wall boundary cells;
   decompose the velocity of the air-WF two-phase flows to obtain the surface velocity of the imaginary WF;
   calculate the normal velocity of the imaginary WF;
(5) calculate the velocity and thickness of the real WF;
(6) choose the Messinger model to find the ice layer thickness if there never has ice on the wall, otherwise go to next step;
(7) refine the grid to cover the WF and the ice layer below to form a phase changing zone;
(8) calculate the temperature distribution within the ice layer and track the icing interface;
(9) convert the un-iced water into the volume fraction of SWD on the wall boundary cells;
(10) remark the wall boundary cells;
(11) increase time step;
(12) go back to step (3) for the next time step computation.

The originalities for the present invention lie in
1. The original computing grid is used as the back ground grid, which doesn't move in any following time step but can be refined locally. It is a unstructured grid system;
2. Around aircraft, the air-SWD single fluid two-phase flows are for the external domain; while the velocity of the air-WF two-phase flow is to be decomposed and the phase changing happens in the wall boundary cells.
3. The solution of governing equations for the temperature distribution and phase changing within the WF-ice layer gives the thickness of ice layer, which is remarked as the boarder for the external domain to do the next time step computation.

The numerical method proposed in this invention does not need to regenerate the computing grid as the technology in the current software, which avoids any grid relevant operation and the variable interpolation operation so that it save the computing time and improve the computing precision. And more, the concurrently obtained information of the ice layer thickness and temperature distribution inside the ice layer is very important to recognize, analyze and design the anti-, de-icing system.

### BRIEF DESCRIPTION OF THE DRAWINGS

The FIG. 1 is flow chart of aircraft flight-icing simulation in FENSAP.

The FIG. 2 is the principle of the velocity decomposition of the air-SWD mixture velocity;
(a) the decomposition of the air-SWD mixture flows and the formation of the imaginary water film in the wall boundary cells.
(b) the incompressible boundary layer of the imaginary water film.
(c) the velocity distribution in the air-water film two-fluid boundary layer.
(d) the velocity distribution in the air-water film mixture boundary layer.
(e) the procedure to calculate the surface velocity of imaginary water film.

The FIG. 3 is the principle of grid refinement to track the icing interface, where
(a) at time step t, 1 is the wall of aircraft; 13 is the ice layer formed in the last time step; 14 is the first cell of in the WF at time step t; 15 is the second cell in that; 16 is the third cell in that.
(b) at time step t+t, 1 is the wall of aircraft; 17 is the first cell in the ice layer formed in the time step t; 18 is the second cell in that; 19 is the third cell in that; while 20 is the first cell in the WF at the time step t+t; 21 is the second in that; 22 is the third cell in that.

The FIG. 4 is the input and output in the icing progress calculation.

The FIG. 5 is the procedure for the numerical simulation for the aircraft flight-icing.

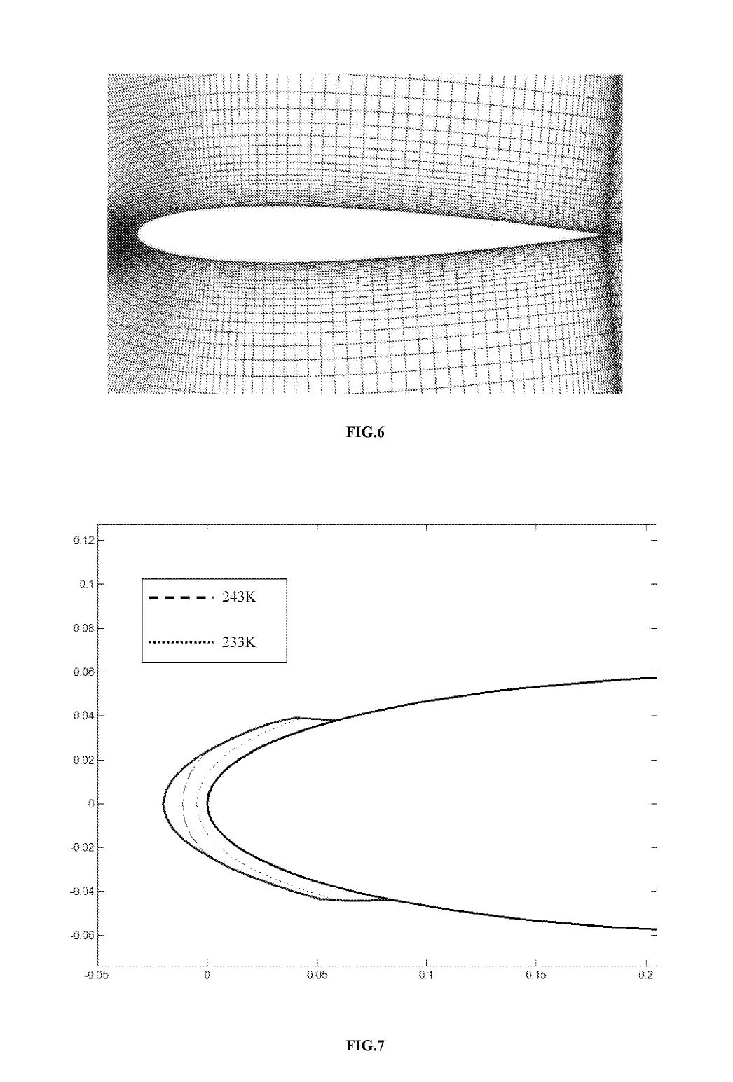

The FIG. 6 is a C-type orthogonal grid around the clean NACA0012 airfoil.

The FIG. 7 is the numerical simulation results for the flight-icing case in the preferred embodiment.

### DETAILED DESCRIPTION OF THE PREFERRED EMBODIMENT

An embodiment according to the invention is illustrated following. It is related to a numerical simulation method for the flight-icing of an aircraft wing with a section view of NACA0012 airfoil. This method can be embodied by using the computer language FORTRAN90 codes and can be run on computers to simulate the state of aircraft flight-icing.

There are some flying conditions for the numerical simulation.

The flying velocity: 57 m/s

The atmosphere temperature: 243K

The atmosphere pressure: 100 kPa

The angle of attack: 0°

LWC: 2.58 g/m³

MVD: 50 μm

The ice density: 917 kg/m³

According to the FIG. 5, the detailed steps in the procedure to simulate the flight-icing are followed:
1. Around the clean NACA0012 airfoil, as shown in the FIG. 6, a C-type orthogonal grid with 256 cells around the wall surface and 96 cells in wall normal direction is generated.
2. Initialize the starting time t=0, and the time step is t.
3. Solve the governing equations for the air-SWD single fluid two-phase flows, which are the volume fraction diffusion equation

$$\frac{\partial {α}^{2}}{\partial t} + ∇ \cdot ( {α}_{2} {{V}^{->}}_{m} ) = 0 ; \qquad ( 14 )$$

the continuity equation

$$\frac{\partial {ρ}_{m}}{\partial t} + ∇ \cdot ( {ρ}_{m} {{V}^{->}}_{m} ) = 0 ; \qquad ( 15 )$$

the momentum equation

$$\frac{\partial ( {ρ}_{m} {{V}^{->}}_{m} )}{\partial t} + ∇ \cdot ( {ρ}_{m} {{V}^{->}}_{m} {{V}^{->}}_{m} ) = - ∇ {p}_{m} + {λ}_{m} ∇ ( ∇ \cdot {V}^{->} ) + ( {μ}_{m} + {μ}_{T} ) ( {∇}^{2} {{V}^{->}}_{m} + ∇ ( ∇ \cdot {{V}^{->}}_{m} ) ) + {ρ}_{m} {g}^{->} ; \qquad ( 16 )$$

the energy equation

$$\frac{\partial ( {ρ}_{m} {E}_{m} )}{\partial t} + ∇ \cdot ( {ρ}_{m} {{V}^{->}}_{m} {E}_{m} ) = - ∇ \cdot ( {p}_{m} {{V}^{->}}_{m} ) + [ {λ}_{m} I ( ∇ \cdot {V}^{->} ) + ( {μ}_{m} + {μ}_{T} ) ( {∇}^{2} {{V}^{->}}_{m} + {{V}^{->}}_{m} ∇ ) ] \cdot ∇ {{V}^{->}}_{m} - ∇ \cdot {{Q}^{->}}_{m} + {ρ}_{m} {g}^{->} \cdot {{V}^{->}}_{m} , \qquad ( 17 )$$

where Eₘ is the energy and Qₘ is the heat flux vector of the mixture, \vec{g} is the unit gravity vector, and λₘ is decided from the Stokes law. The set of PDE is solved based on FVM with the cell centered, the publicly known second-order Roe spatial and LU-SGS temporal discretization scheme.
4. Decompose the velocity of the air-SWD two-phase flows to obtain the velocity and thickness of the IWF, according to the principle and procedure introduced in the FIG. 2.
5. Find the normal velocity of the IWF, v₂, according the equation (11).
6. Find the velocity and thickness of the WF according the equation (12).
7. Find the surface velocity of WF \vec{U}_{2f} using linear interpolation.
8. Solve the publicly known Messinger model.
9. Refine the grid in the wall boundary cells to constitute the phase changing zone.
10. Solve the icing progress model to find the temperature distribution in the ice layer and track the icing interface.
   The icing progress model includes a set of PDE built in the local coordinator system, where ξ,ζ is the two orthogonal direction and the ζ—is the wall normal direction. The governing equations are for the incompressible flows with the phase changing in the phase changing zone. The velocity component u, v is the WF velocity in the ξ,ζ direction; pressure is p; density is ρ; the specific heat at constant pressure is Cₚ; the thermal conductivity k; the icing latent heat is L. The subscript w indicates the water; while i does the ice. In detailed,
   the continuity equation is

$$\frac{\partial u}{\partial ξ} + \frac{\partial v}{\partial ϛ} = 0 ; \qquad ( 18 )$$

the energy equation is

$$\frac{\partial ( {ρ}_{*} {C}_{p *} T )}{\partial t} + \frac{\partial ( u {C}_{p *} T )}{\partial x} + \frac{\partial ( v {C}_{p *} T )}{\partial y} = \frac{\partial }{\partial x} ( {k}_{*} \frac{\partial T}{\partial x} ) + \frac{\partial }{\partial x} ( {k}_{*} \frac{\partial T}{\partial y} ) - L [ \frac{\partial f}{\partial t} + \frac{\partial ( u f )}{\partial x} + \frac{\partial ( v f )}{\partial y} ] , \qquad ( 19 )$$

where, f, the liquid ratio is defined as

$$\begin{matrix}f = \frac{{ρ}_{*} {C}_{p *} T - {ρ}_{i} {C}_{p i} T}{{ρ}_{w} {C}_{p w} T - {ρ}_{i} {C}_{p i} T} ; \\ with & ( 20 ) \\ {ρ}_{*} = f {ρ}_{w} + ( 1 - f ) {ρ}_{i} ; & ( 21 ) \\ {k}_{*} = f {k}_{w} + ( 1 - f ) {k}_{i} ; & ( 22 ) \\ {C}_{p *} = f {C}_{pw} + ( 1 - f ) {C}_{pi} + L \frac{\partial f}{\partial T} , & ( 23 )\end{matrix}$$

the momentum equation is

$$\begin{matrix}\frac{\partial u}{\partial t} + \frac{\partial ( u u )}{\partial ξ} + \frac{\partial ( u v )}{\partial ϛ} = - \frac{1}{{ρ}_{w}} \frac{\partial p}{\partial ξ} + [ \frac{\partial }{\partial ξ} ( {v}_{*} \frac{\partial u}{\partial ξ} ) + \frac{\partial }{\partial ϛ} ( {v}_{*} \frac{\partial u}{\partial ϛ} ) ] - {g}_{ξ} - D ; & ( 24 ) \\ \frac{\partial v}{\partial t} + \frac{\partial ( vu )}{\partial ξ} + \frac{\partial ( vv )}{\partial ϛ} = - \frac{1}{{ρ}_{w}} \frac{\partial p}{\partial ϛ} + [ \frac{\partial }{\partial ξ} ( {v}_{*} \frac{\partial v}{\partial ξ} ) + \frac{\partial }{\partial ϛ} ( {v}_{*} \frac{\partial v}{\partial ϛ} ) ] - {g}_{ξ} - D , & ( 25 )\end{matrix}$$

where the drag

$$D = \{ \begin{matrix}0 , ɛ < f \leq 1 \\ A , f \leq ɛ\end{matrix} , \qquad ( 26 )$$

where A is a big number with 10⁷ and ε is an artificial parameter with 0.001.
It is usually to use the pressure-based method, such as SIMPLE method, to solve the governing equations for the incompressible flows, which is publicly known. The solution gives the velocity and the temperature distribution in the phase changing zone. The icing interface is judged using the liquid ratio.
11. Convert the un-iced WF into the volume fraction of SWD according the equation (13);
12. Remark the wall boundary cells;
13. Go back to step (2) to continue the computation for the next time step.

The FIG. 7 presents the numerical simulation results for the flight-icing case in the preferred embodiment. The results include the two-dimensional ice shape around the airfoil leading-edge and the Iso-temperature contour inside the ice layer. From the results, one can find that the maximum thickness of the ice is about 0.02 time chord length and the temperature is evenly distributed. The temperature in the center of ice layer is a little lower than that in the wall and in the atmosphere.

What is claimed is:

1. a computer implemented numerical method for simulating aircraft flight-icing, includes an algorithm for velocity decomposition on water film in wall boundary computing cells when simulating air-supercooled water droplets movement using a single fluid two-phase flows system; an algorithm for tracking icing interface and obtaining temperature distribution inside ice layer using the grid refinement scheme; a computing procedure using above-mentioned algorithms based on a fixed computing grid.

2. The method of claim 1, wherein said algorithm about velocity decomposition on water film in wall boundary computing cells when simulating air-supercooled water droplets movement using a single fluid two-phase flows system includes the following steps:
(1) Producing an imaginary water film with a thickness decided by volume fraction of supercooled water droplets in said wall boundary computing cells on the surface of aircraft;
(2) Initializing v, a kinetic viscosity for imaginary water film;
(3) finding u_{2f}, a surface velocity of imaginary water film, according to the incompressible flow boundary layer theory;
(4) calculating u₂, imaginary water film velocity, according to
$${u}_{2} = \frac{1}{2} {u}_{2 f} ;$$
(5) calculating u₁, air velocity, according to
$${u}_{1} = \frac{{ρ}_{m} {u}_{m}}{{α}_{1} {ρ}_{1}} - {u}_{2} ,$$
where ρₘ and μₘ are respectively density and velocity of said single fluid two-phase flows;
(6) integrating velocity across air-imaginary water film two-fluid flow boundary layer to get value S and integrating velocity across air-supercooled water droplets mixture boundary layer to get value Sₘ;
(7) measuring S and Sₘ, if their differential under specified error, going to step (9);
(8) going back to step (3) with an adjusted v to find u_{2f};
(9) calculating v₂, a normal velocity inside imaginary water film, following the incompressible boundary layer theory;
(10) modifying thickness of imaginary water film by multiplying normal velocity of imaginary water film with a characteristic integration time;
(11) obtaining \vec{U}_{2f}, surface velocity of said water film, based on an assumption of linear velocity distribution in boundary of said water film.

3. The method of claim 1, wherein said algorithm about tracking icing interface and obtaining temperature distribution inside ice layer using a grid refinement scheme, needs at least three layers of new computing cells in wall boundary cells in the bottom of said water film and another three ones inside said ice layer, those six cells refine the original computing cells and constitute a phase changing zone, where water changes into ice and new icing interface appears.

4. The method of claim 1, wherein said computing procedure
(1) generating said computing grid for a non-iced aircraft;
(2) initializing a starting time;
(3) solving a set of governing equations for said air-supercooled water droplets single fluid two-phase flows for aircraft external flow field simulation;
(4) calculating the thickness of the imaginary water film in said wall boundary computing cells;
(5) acting said velocity decomposition;
(6) calculating thickness of said water film;
(7) choosing the Messinger model to find ice layer thickness if there never has ice on aircraft surfaces, otherwise going to next step;
(8) refining said computing grid to cover said water film and ice layer to form a phase changing zone;
(9) calculating the temperature distribution within ice layer and tracking said icing interface;
(10) converting un-iced water into the volume fraction of said supercooled water droplets on said wall boundary computing cells;
(11) remarking said wall boundary computing cells;
(12) increasing time step;
(13) going back to step (3) for the next time step computation.
